(19) United States
(12) Patent Application Publication
(10) Pub. No.: US 2013/0333366 A1
(43) Pub. Date: Dec. 19, 2013

(54) HYDRAULIC DEVICE FOR ACTUATING A CLUTCH

(71) Applicant: Schaeffler Technologies AG & Co., KG, Herzogenaurach (DE)

(72) Inventors: Marco Grethel, Buhlertal (DE); Andreas Englisch, Buhl (DE); Eric Muller, Kaiserslautern (DE)

(73) Assignee: Schaeffler Technologies AG & Co., KG, Herzogenaurach (DE)

(21) Appl. No.: 13/974,221

(22) Filed: Aug. 23, 2013

Related U.S. Application Data
(63) Continuation of application No. PCT/DE2012/000129, filed on Feb. 14, 2012.

(30) Foreign Application Priority Data
Feb. 23, 2011 (DE) 102011012180.3
Sep. 30, 2011 (DE) 102011083880.5

(51) Int. Cl. F15B 15/18

(52) U.S. Cl. CPC F15B 15/18
USPC 60/327; 60/428

(57) ABSTRACT

A hydraulic device, in particular for actuating a clutch, including a hydraulic working cylinder, which is arranged near the clutch and which is connected to a volumetric flow source via a hydraulic line. The volumetric flow rate of the volumetric flow source can be influenced by a control unit according to signals of the sensors associated with the hydraulic device. The volumetric flow source is formed by a combination of an electric motor and a pump arranged in a common housing.

### INCORPORATION BY REFERENCE

The following documents are incorporated herein by reference as if fully set forth: International Patent Application PCT/DE2012/000129, filed Feb. 14, 2012; German Patent Application 102011012180.3, filed Feb. 23, 2011; and German Patent Application 102011083880.5, filed Sep. 30, 2011, 2011.

### BACKGROUND

The invention relates to a hydraulic device for actuating a clutch.

Hydraulic force-transmission linkages with slave and master cylinders are known. The hydraulic slave cylinder is here arranged physically close to the clutch. For automatic transmission linkages, the master cylinder can be constructed as a volumetric flow source that can be controlled and/or regulated.

In principle, two types of volumetric flow sources for such force-transmission linkages are known. In one case, one solution involves a sub-function of a more complicated hydraulic control that can also fulfill other tasks. The volumetric flows of a mechanically or electrically driven hydraulic pump are distributed by valve logic and a partial flow is used for actuating the clutch. This solution is complicated if only one or two hydraulic functions are required.

In another case, a so-called hydrostatic actuator is used as the volumetric flow source. Such solutions are described, for example, in publication WO 2011050767 A1. Here, a rotational movement of an electric drive is transmitted to a threaded spindle that is in contact with other threaded spindles arranged as planets about the threaded spindle and in this way a linear movement of the planets is generated that are connected, in turn, to a displacing piston and move this back and forth in a linear movement. However, the large translation ratio of the rotational movement into the linear movement adversely affects the hysteresis behavior and the dynamic response.

### SUMMARY

The object of the invention is to provide a hydraulic device for actuating a clutch, wherein this hydraulic device can be constructed as a compact unit, has a considerably improved response behavior, can be integrated into control systems inside the vehicle but could also be operated by itself, has an essentially maintenance-free operation, and, incidentally, does not have the disadvantages displayed by the solutions of the prior art.

This objective is met with a hydraulic device for actuating a clutch with one or more features of the invention.

Accordingly, the present invention relates to a hydraulic device, in particular, for the actuation of a clutch, with a hydraulic work cylinder arranged close to the clutch, wherein the work cylinder is connected to a volumetric flow source by a hydraulic line. The volumetric flow of the volumetric flow source can be influenced by a control unit as a function of signals of the sensors allocated to the hydraulic device. The volumetric flow source is formed by a combination or unit comprised of an electric motor and a pump arranged in a shared housing.

According to the present invention, the hydrostatic actuator described above is improved such that advantageously instead of a voluminous displacing piston and a complicated planetary drive, a comparatively simple pump arrangement can be used whose rotational speed can be reversed. According to one advantage of the present invention, such a device can be built smaller than a hydrostatic actuator and can be adapted to the conditions of use in many ways, wherein the freedom of movement in the arrangement or in the installation is also improved. The solution according to the invention thus provided by replacing the displacing piston and the planetary drive of the hydrostatic actuator by a special pump arrangement.

The hydraulic device according to the invention can be used, for example, for supplying and driving single-acting hydraulic cylinders. A combination of an electric motor and a hydraulic pump is designed so that quick pressure build-up and, if necessary, a quick change in the rotational direction are possible. Electric motors and pumps are therefore designed so that they can react with a high dynamic response to changes. Rotating parts are therefore given the smallest possible dimensions to reduce inertia.

For the hydraulic pumps, advantageously any embodiment that can guarantee a large volumetric flow and a high pressure level immediately at startup is suitable. Suitable designs here are gear-type, impeller, rotary vane, radial piston, or axial piston pumps.

If a clutch is actuated with the present hydraulic device, the pump is driven by the electric motor, so that the fluid is fed in the direction toward the working cylinder (slave cylinder). A sensor system here monitors the actuation state of the clutch, the clutch release, or the working cylinder. Through the use of sensor signals, the pump rotational speed and/or the pump running period can be continuously regulated, in order to maintain the targeted state of the clutch. The sensor signal can be generated by a displacement measurement on the clutch or a pressure measurement in the hydraulic train to the clutch or by both.

For holding the clutch in the targeted position, there are the following preferred possibilities. In one case, the rotational speed of the pump is reduced so much that it compensates only for its own leakage flow. That is, the pump maintains the pressure without feeding additional fluid into the hydraulic section to the clutch and the clutch is subject to an additional actuation. Thus, only the leakage flow is compensated. Here it is advantage that no other components are required for holding the clutch position. However, energy must be applied continuously for holding the clutch.

In the other case, a valve is provided that closes the hydraulic section between the pump and clutch as soon as the targeted position of the clutch is reached. With special advantage, a seat valve (non-return valve) is selected as the valve. The very low leakage of the seat valve makes it possible that the pump and thus the electric motor do not need to be driven continuously in order to keep the clutch in the targeted position. The energy requirement for the actuation of the valve is here lower than the operation of the electric motor for holding the clutch without a valve. However, an additional component in the form of an electromagnet is needed for actuating the valve.

For deactivating the clutch, the following strategies can be used. The pump can be actively operated against its pumping direction (reversed) in order to quickly empty the hydraulic section. In this procedure it can be necessary that the actuation state of the clutch is monitored by sensors. According to the so-called kiss point of the clutch, usually a large dynamic response is not required or only a smaller dynamic response with respect to the additional opening. To prevent an emptying of the hydraulic section, above the kiss point or shortly thereafter the pump rotational speed can be brought to zero. The residual emptying of the hydraulic section can then be performed by the gaps of the pump.

For dynamically non-critical procedures, it is imaginable that the energy stored in the clutch and the hydraulic section can be partially recovered. The pump then operates as a hydraulic motor and the electric motor as a generator.

If the system also still has a locking valve, this must be opened at the same time as or before the deactivation of the clutch. Someone skilled in the art can design the hydraulic system of the device in various ways. It can be designed, for example, according to the requirements of the clutch to be controlled, according to external requirements, such as when the vehicle is being operated, as well as in terms of optimization and energy aspects.

In one advantageous construction of the invention, it is also possible to arrange a pressure accumulator between the clutch and the valve in the shared housing. This pressure accumulator can be constructed, for example, as a plate spring accumulator. The pressure accumulator can fulfill two different functions according to its design. On one hand, it can cause a reduction of the power requirements during the actuation process and, on the other hand, it can provide volume tracking when the clutch is held in place for compensating for leaks.

In addition to the supply described above of a single-acting cylinder, by use of the reversing pump unit that is made from an electric motor with electronics for controlling and/or regulating the pump output and the hydraulic pump, a double-acting cylinder can also be driven. In the simplest case, by use of the reversing pump unit, the volume can be selectively fed from one cylinder chamber into the other cylinder chamber. If the volumes of the two cylinder spaces have different sizes, a simple recirculating of the fluid from one cylinder space into the other is not possible. In this case, an arrangement of so-called re-suction valves and over-pressure valves can provide for a compensated fluid balance.

The hydraulic device according to the invention with the combination of the electric motor and pump can advantageously be built very compactly and have the following features. The rotor and the stator of the electric motor can share a common housing with the displacing unit of the pump. The rotor of the electric motor can be supported completely or partially in the sleeve bearings of the gear-type pump. A bearing point of the electric motor or the pump can also be placed in the valve or the pressure accumulator housing. The valve unit and the plate spring pressure accumulator can share another housing part. The supply space can be arranged between the motor/pump housing and the valve or pressure accumulator housing. According to the use case, the valve unit can be exchanged and optionally the storage function can be eliminated. The system-relevant sensors, i.e., the rotational speed, rotational angle, and/or pressure sensors can be integrated directly into the control electronics of the electric motor/pump combination. In many cases, the special compactness of this combination allows a physical closeness to the actuator, so that a displacement measurement can also be integrated into the control electronics. The coil for the electromagnet of the valve can likewise be integrated directly into the control unit.

In another embodiment of the invention, a bypass diaphragm or a bypass throttle can be provided between the pump connections, in order to cause a desired “worsening” of the volumetric efficiency of the pump. Thus, the “pressure holding rotational speed” is increased and the controllability of the pressure is improved.

### BRIEF DESCRIPTION OF THE DRAWINGS

The invention is explained in more detail below with reference to embodiments and drawings. Shown are:

FIG. 1 is a hydraulic schematic diagram of a hydraulic device according to the invention with a single-acting hydraulic cylinder with spring resetting and with an electrically driven reversing pump, a control valve, a high tank, and a pressure sensor,

FIG. 2 is a view of a device according to the invention that has been further improved in comparison to the device of FIG. 1, wherein an additional pressure accumulator is provided,

FIG. 3 is a view of a hydraulic device according to the invention in which a bypass is arranged parallel to the reversing pump,

FIG. 4 is a view of a hydraulic device according to the invention for driving a double-acting working cylinder,

FIG. 5 is a perspective view of the hydraulic device according to the invention with a compact unit housing for all components of the device, partially in an exploded view, and

FIG. 6 is a cross-sectional view of the compact unit housing of FIG. 5 with all individual components arranged therein.

### DETAILED DESCRIPTION OF THE PREFERRED EMBODIMENTS

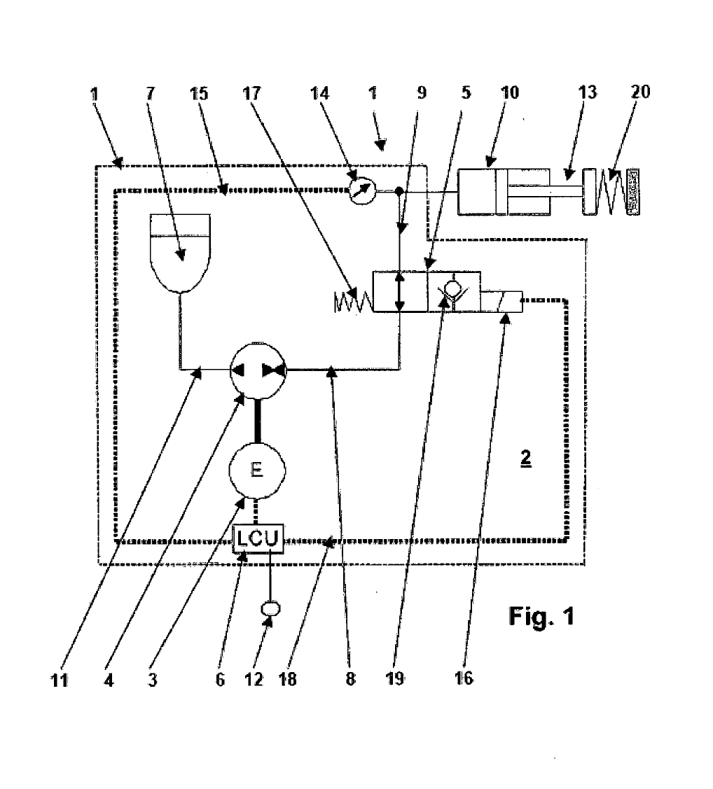

The basic schematic diagram of the present hydraulic device is shown in FIG. 1.

A hydraulic device 2 is arranged within a shared housing 1 shown schematically by a dashed outline. This is formed essentially from an electric motor 3 that is connected with a non-positive fit to a displacing pump 4, a 2/2 control valve 5, an electric control unit 6, a storage container 7, a hydraulic line 8 between the displacing pump 4 and the input of the 2/2 control valve 5, a hydraulic line 9 between the output of the 2/2 control valve 5, and a working cylinder 10, as well as a hydraulic line 11 between the displacing pump 4 and the storage container 7.

The control unit 6 is connected by a connection 12 to a control device of a higher-level system, e.g., with sensors on a clutch pedal and/or with other sensors that determine certain states within a drive train. From these states or through manually triggered commands, the control unit can generate a signal that can start the electric motor 3. When the electric motor 3 starts up, the displacing pump 4 starts up simultaneously. It suctions hydraulic fluid from the storage container 7, wherein a higher pressure is established in the line 8. The 2/2 control valve 5 is connected in its output position so that the line 8 and the line 9 are connected to each other, so that a pressurized volumetric flow acts on the working cylinder 10 and the piston rod 13 is extended for actuating a not-shown clutch.

If the control unit 6 generates a command that ends the work cycle of the working cylinder 10, in turn, based on the signals supplied from the outside, it controls the electric motor 3 and the displacing pump 4 in the opposite rotational direction, so that the working cylinder 10 is emptied and therefore retracted. The suctioned volumetric flow is fed back into the storage container 7.

In the operation described above, the 2/2 control valve 5 could also be eliminated and the lines 8 and 9 could be connected directly to each other.

The displacing pump 4 can be a pump of arbitrary construction if it can supply the required volumetric flow and can reach the required pressure level. In particular, hydraulic pumps are suitable as displacing pumps 4 that can execute quick rotational speed changes, including quick startups and changes in rotational direction. Especially suitable are pumps, for example, external gear-type pumps in which the displacement spaces are defined geometrically or are stabilized.

A pressure sensor 14 can be connected by a signal line 15 to the control unit 6, so that this control unit can stop the pump process as soon as the pressure level necessary for a successful work cycle of the working cylinder 10 is reached.

Likewise, the control unit 6 can evaluate measurement signals of the pressure sensor 14 and the displacing pump 4 intermittently or also let it run at a lower rotational speed, in order to maintain a pressure level that is decreasing due to leaks.

The arrangement of the 2/2 control valve 5 is a preferred embodiment of the hydraulic device and can be controlled by an electromagnet 16 and can be reset by a spring element 17. In its shown first position that forms the output position, the 2/2 control valve 5 creates a connection between the displacing pump 4 and the working cylinder 10. As soon as the pressure sensor 14 reports to the control unit 6 that the required pressure level has been reached, the control unit 6 can drive the electromagnet 16 via the electric line 18 and can control the 2/2 control valve 5 into the second position in which a seat valve 19 of the 2/2 control valve 5 prevents back flow of the hydraulic medium.

In this use case, the displacing pump 4 must be operated in an energy-saving way only until the required pressure level is reached and by switching the control valve 5 into the second position, the working cylinder 10 is held in the extended position.

A typical clutch includes a spring arrangement 20 that resets the working cylinder 10 into the output position, otherwise a separate spring arrangement 20 can be provided for resetting.

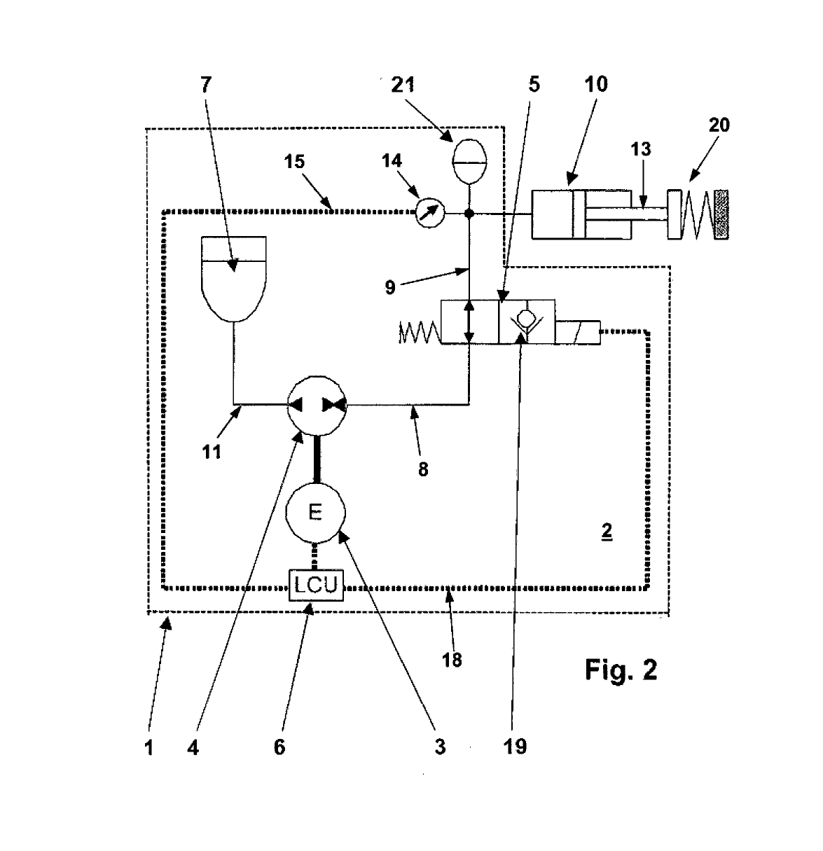

According to FIG. 2, an improved embodiment is provided in the area of the line 9 in addition to a pressure accumulator 21 that can be constructed, for example, as a plate spring accumulator. This can ensure, by volume tracing when the extended state of the working cylinder 10 is reached in the second position of the 2/2 control valve 5 that leak flows are compensated and the required pressure level in the line 9 and in the working cylinder 10 is maintained. In addition, an integration of the output requirements in the actuation process can be fulfilled.

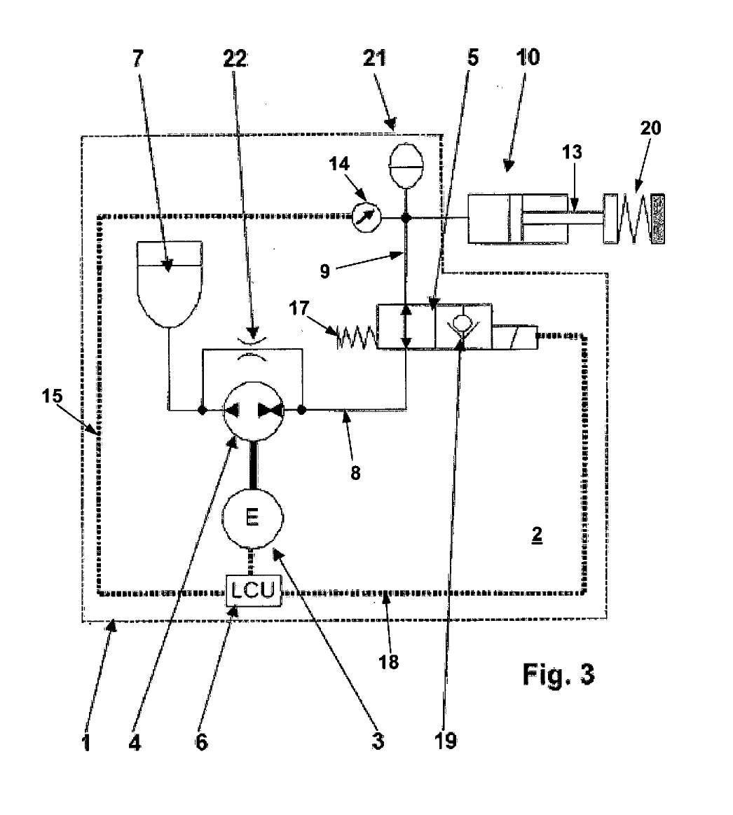

Another preferred embodiment of the hydraulic device comprises, according to FIG. 3, a bypass diaphragm or throttle device 22 arranged parallel to the displacing pump 4. The loss flow occurring across the throttle device 22 indeed intentionally reduces the volumetric efficiency of the displacing pump 4. This has the result that the required rotational speed of the electric motor 3 for regulating a defined pressure in the working cylinder 10 is higher, but represents significant advantages with respect to the rotational speed control/rotational speed regulation for small required supply flows.

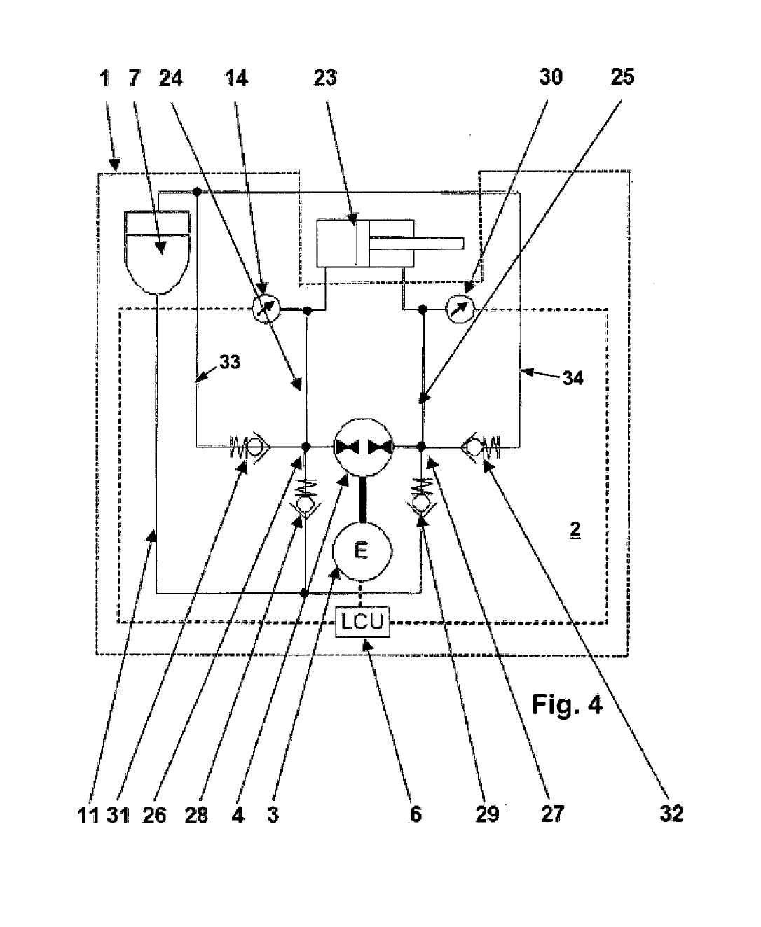

Another embodiment of the hydraulic device provides, according to FIG. 4, a working cylinder 23 in a double-acting design. The displacing pump 4 is here controlled by the electric motor 3 so that it fills the working cylinder 23 (left chamber) via the line 24 and extends it. At the end of the work cycle, the displacing pump 4 is adjusted or reversed. It then fills the working cylinder 23 (right chamber) via the line 25, wherein this cylinder is then retracted again. The two connections 26 and 27 of the displacing pump 4 are connected to the line 11 and the storage container 7 with intermediate placement of the seat and/or non-return valves 28 and 29. According to the rotational direction of the displacing pump 4, the seat valve 29 opens when the working cylinder 23 is extended and the seat valve 28 opens when this working cylinder is retracted. For the case that the pressure sensors 14 or 30 allocated to the inputs of the working cylinder 23 signal a pressure loss, the control unit 6 can let the displacing pump 4 continue to run, wherein too high a supplied volumetric flow is discharged via the pressure limiting valves 31 and 32 and is fed via the lines 33 or 34 to the storage container 7.

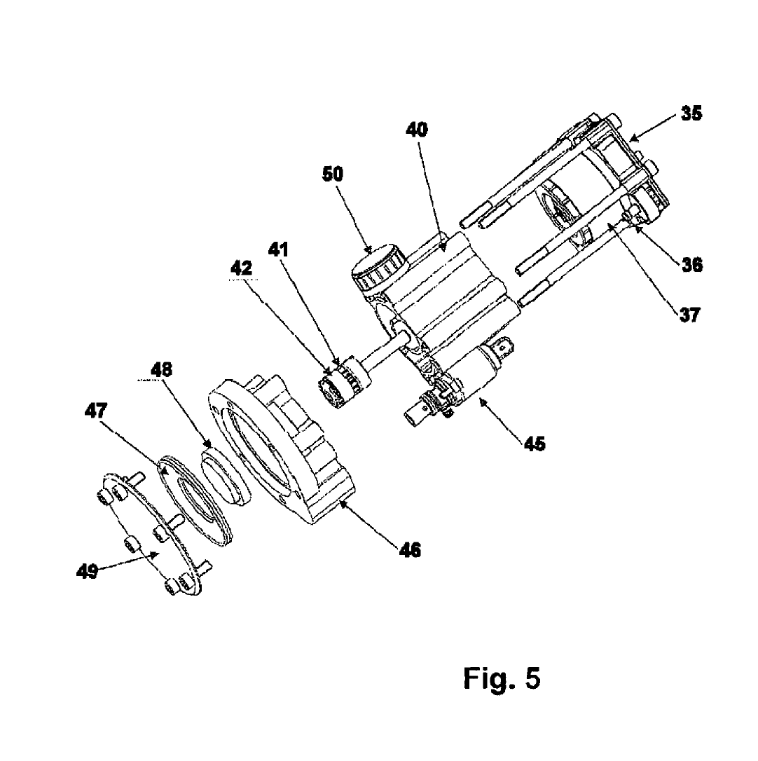

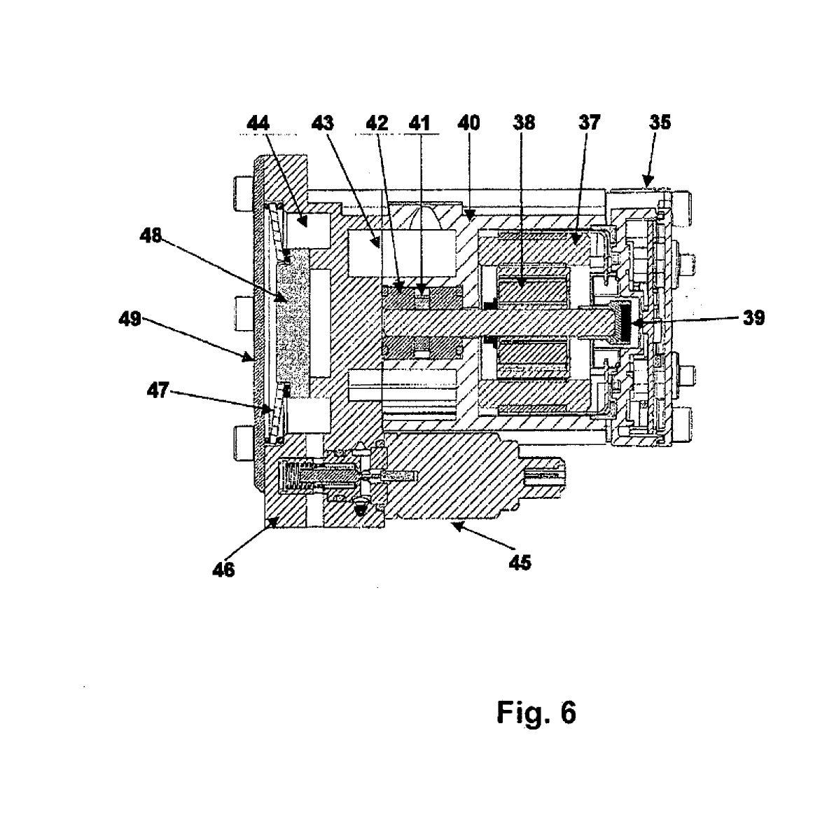

In connection with FIGS. 5 and 6, a currently preferred embodiment of the invention is described below.

With a modularly designed housing that comprises a local control device 35, a motor-pump housing 40, a valve-pressure accumulator housing 46, a closing cover 49, and a 2/2 control valve 45 flanged on the valve-pressure accumulator housing 46, a compact structural unit is constructed that combines all functions with respect to storage of the hydraulic medium, generation of a volumetric flow, and signal processing.

For its use, this compact structural unit requires only the production of the hydraulic and the electrical connections and the connections of the sensors arranged outside. The compactness of this structural unit makes it possible to arrange it at places within vehicles or systems, largely free from restrictions. This produces, for example, the ability to arrange the compact structural unit close to the hydraulic working cylinder (slave cylinder) actuating the clutch.

In the motor-pump housing 40, the stator 37 and the rotor 38 of the electric motor are arranged so that the shaft of the electric motor can support the impeller 41. The sleeve bearings 42 are arranged on both sides of the impeller 41, wherein the overall arrangement corresponds to the construction of a gear-type pump. The sleeve bearings 42 of the impeller 41 also form the support of the rotor 38 of the electric motor. Alternatively, one of the two bearing points could also be housed in the valve-pressure accumulator housing 46. Obviously, the second bearing point could also be moved analogously from the sleeve bearing into the motor-pump housing 40.

The motor-pump housing 40 and the closing cover 49 together form a supply space 43 that holds the hydraulic medium. A filling opening allows the supply space 43 to be filled. It is covered with a sealing cap 50.

The storage space 44 is also arranged in the closing cover 49. This storage space has a variable volume in interaction with a middle cover 48 and a plate spring 47 and takes over the task of a pressure accumulator as mentioned above.

A 2/2 control valve 45 is arranged between the closing cover 49 and the motor-pump housing 30. It is used for controlling the volumetric flow to be fed to the slave cylinder.

A rotational speed-rotational angle sensor 39 is also combined with the local controller 35 (FIG. 6), so that the compact hydrostatic device can be controlled exactly for actuating the clutch.

The assembly of the individual segments of the hydraulic device can be realized in various ways, for example, by bolting the structural units together, by suitable, non-detachable connections between the units, or by stud bolts as shown in FIGS. 5 and 6.

The application of the hydraulic device according to the invention is limited not only to the actuation of clutches, for example, clutches for dual-clutch transmissions, hybrid differential-type linkages, conventional stepped automatic transmissions, and manual transmissions in general. The present hydraulic devices can also be used for shifting all wheel drives (AWD) or for actuating a differential gear or parking lock. In addition to their use for clutches, hydrostatic devices that interact with double-acting working cylinders can also be used for gear changing devices, AWD shifting, and parking lock switches.

The invention thus advantageously creates the ability to construct a compact hydraulic device adapted to the corresponding requirements profile so that it can be controlled precisely, can operate in an energy-efficient manner, and also can be installed without a problem in the discussed areas of application due to its compact construction.

### LIST OF REFERENCE NUMBERS

1 Housing

2 Hydraulic device

3 Electric motor

4 Displacing pump

5 2/2 control valve

6 Control unit

7 Storage container

8 Line

9 Line

10 Working cylinder

11 Line

12 Connection

13 Piston rod

14 Pressure sensor

15 Signal line

16 Electromagnet

17 Spring element

18 Line

19 Seat valve

20 Spring arrangement

21 Pressure accumulator

22 Throttle device

23 Working cylinder

24 Line

25 Line

26 Connection

27 Connection

28 Seat valve

29 Seat valve

30 Pressure sensor

31 Pressure limiting valve

32 Pressure limiting valve

33 Line

34 Line

35 Local controller

36 Integrated pressure sensor

37 Stator

38 Rotor

39 Rotational speed-rotational angle sensor

40 Motor-pump housing

41 Pump wheel

42 Sleeve bearing

43 Supply space

44 Storage space

45 2/2 control valve

46 Valve-pressure accumulator housing

47 Plate spring

48 Middle cover

49 Closing cover

50 Sealing cap

1. A hydraulic actuating device, comprising a hydraulic working cylinder arranged in proximity to a device to be actuated, a volumetric flow source connected to the working cylinder by a hydraulic line, the volumetric flow source having a volumetric flow, sensors allocated to the hydraulic actuating device, a control unit that controls the volumetric flow as a function of signals of the sensors, and the volumetric flow source is formed by a combination of an electric motor and a hydraulic pump arranged in a shared housing.

2. The hydraulic device according to claim 1, wherein the pump is a displacing pump comprising a gear-type pump, an impeller pump, a radial piston pump, or an axial piston pump.

3. The hydraulic device according to claim 1, wherein the combination of the electric motor and the pump is operable in two rotational directions.

4. The hydraulic device according to claim 1, further comprising a throttle device connected in parallel to the pump.

5. The hydraulic device according to claim 1, wherein the control unit is arranged in the shared housing.

6. The hydraulic device according to claim 1, wherein at least one of a storage container for the hydraulic medium or a pressure accumulator are arranged in the shared housing.

7. The hydraulic device according to claim 1, wherein the control unit comprises components that process measurement signals from the sensors which are arranged inside or outside the hydraulic device, and the measurement signals comprise signals from at least one of the electric motor, the pump, pressure measurement values and displacement measurement values of the working cylinder, or signals from an external element driven by the working cylinder.

8. The single-acting working cylinder, a single-acting working cylinder with a spring hydraulic device according to claim 1, wherein the working cylinder is a arrangement for resetting or a double-acting working cylinder.

9. A method for actuating a working cylinder with a hydraulic device that comprises a volumetric flow source connected to the working cylinder by a hydraulic line, the volumetric flow source having a volumetric flow, sensors allocated to the hydraulic actuating device, a control unit that controls the volumetric flow as a function of signals of the sensors, and the volumetric flow source is formed by a combination of an electric motor and a hydraulic pump arranged in a shared housing, the method comprising the hydraulic device receiving a start command generated by a control element or by a controller of the control unit, the control unit then setting the combination of the electric motor and the pump in operation and executing at least one work cycle through which the working cylinder is extended, and the control unit causing a pressure drop in the hydraulic line after receiving a completion signal, and retracting the working cylinder.

10. The method according to claim 9, further comprising, after pressure has built up in the working cylinder, closing a seat valve in order to close a hydraulic connection between the pump and the working cylinder.

11. Method according to claim 10, wherein the pressure drop is realized after completion of a working cycle by a pressure release in the working cylinder, by opening the seat valve, by controlling the combination of the electric motor and the pump in a reverse operation, or by gap losses in the pump.
